(19) United States
(12) Patent Application Publication
(10) Pub. No.: US 2007/0297344 A1
(43) Pub. Date: Dec. 27, 2007

(54) System for determining an optimal arrangement of servers in a mobile network

(75) Inventors: Michael James Hartman, Clifton Park, NY (US); Amit Bhavanishankar Kulkarni, Clifton Park, NY (US); Richard Martin Spackmann, Saratoga Springs, NY (US)

Correspondence Address: TAROLLI, SUNDHEIM, COVELL & TUMMINO LLP, Suite 1700, 1300 East Ninth Street, Cleveland, OH, 44114, US

(73) Assignee: Lockheed Martin Corporation

(21) Appl. No.: 11/471,899

(22) Filed: Jun. 21, 2006

(51) Int. Cl. H04L 12/28; H04L 12/56

(52) U.S. Cl. 370/254; 370/400

(57) ABSTRACT

A system determines an optimal arrangement of servers within a mobile network. The system includes a plurality of nodes of the mobile network. Each node decides whether to become a server by determining whether a cost of accessing a server is greater than a cost of synchronization with another server. The system attains and remains in a stable state by the decisions of each individual node.

### FIELD OF INVENTION

The present invention relates to a system for determining an optimal arrangement of servers, and more particularly, to a system for determining an optimal number and location of servers in a mobile network.

### BACKGROUND OF THE INVENTION

Functionality of distributed networks is typically distributed amongst network nodes to provide both redundancy and fault tolerance should routes change or terminate (i.e., losing connectivity due to line of sight (LOS) restrictions, etc.). Thus, questions regarding the configuration of the distributed functionality naturally arise (i.e., What is the optimal number of servers required given current network size and topology?, Where is the optimal locations of the servers such that all clients are served adequately?, etc.).

Conventional feedback-based and open-loop based control algorithms solve some aspect of these issues. However, these algorithms perform well only under a limited range of network behavior. Outside that range, performance is sub-optimal.

### SUMMARY OF THE INVENTION

A system in accordance with the present invention determines an optimal arrangement of servers within a mobile network. The system includes a plurality of nodes of the mobile network. Each node decides whether to become a server by determining whether a cost of accessing a server is greater than a cost of synchronization with another server. The system attains and remains in a stable state by the decisions of each individual node.

A computer program product in accordance with the present invention determines an optimal arrangement of servers within a mobile network. The computer program product includes: a first instruction for deciding whether to become a server by each of a plurality of nodes; a second instruction for determining whether a cost of accessing a server is greater than a cost of synchronization with another server; a third instruction for performing the second instruction by each of the plurality of nodes; and a fourth instruction for attaining and remaining in a state determined by the third instruction until a change occurs to the network.

A method in accordance with the present invention determines an optimal arrangement of servers within a mobile network. The method includes the steps of: deciding whether to become a server by each of a plurality of nodes; determining whether a cost of accessing a server is greater than a cost of synchronization with another server; performing the determining step by each of the plurality of nodes; attaining and remaining in a state determined by the performing step until a change occurs to the network; and removing the network from a state having no servers.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a schematic representation of example data of a system in accordance with the present invention;

FIG. 2 is a schematic representation of an example system in accordance with the present invention; and

FIG. 3 is a schematic representation of an example computer program product in accordance with the present invention.

### DESCRIPTION OF AN EXAMPLE EMBODIMENT

A system in accordance with the present invention may inherently reorganize itself into one of several stable states based on simple “order parameters” derived from localized state information. The system thus makes distributed network services robust and self-adaptive.

The system may autonomously distribute network servers based on clients/services that need to access the service, adjusts the number of servers, and places the servers in locations that can tolerate changes in the system. Based on tunable parameters, the system may create new servers, as required, to compensate for any loss of connectivity. The system may also terminate redundant servers to maintain optimality.

The system may track an “order parameter”, which is composed from local state information. The system may automatically change state based on the behavior of the order parameter. The system states may follow a state trajectory, i.e., the system chooses only those stable states that minimize (or maximize) the order parameter. Thus, the system may quickly adapt to large changes in system environment and stay in a stable state, unaffected by small changes, to prevent oscillatory behavior. Since this is based purely on local information, the system requires no global message exchange for fast reaction times and low overhead.

The system may react rapidly to environment changes that are observed via changes to the order parameter. All affected parts of the system may detect the change locally and react independently to send the system into a different state.

State trajectories may ensure that the system quickly settles into a stable state optimized for the given environment. The system may have minimal overhead because its decisions are based purely on local information without any global message exchange. The system may choose optimal configuration because the stable states of the system are those which minimize (or maximize) the order parameter. The system may be self-configuring. The system may operate across a large range of environmental conditions thus reducing engineering pitfalls.

The system may be applied to a distributed publish-subscribe service operating in a mobile adhoc network.

The identification and calculation of an order parameter may be based on local state information that is used by the network service to change state. The system may take an order parameter as input and effect change of state of the system.

A dynamic ad hoc wireless network (DAHWN) may have the following self-organizing and emergent properties: Publish Subscribe Server (PSS) and routing and addressing. These properties may optimize themselves based on a network spontaneously formed by the system by a given set of nodes that compose a DAHWN network.

A first relevant factor to the functionality of the system is the cost associated in accessing the PSS and querying the PSS to determine the location of a particular service. This cost may be measured as a hop count. As a node gets farther away from the PSS, the cost associated in querying that node increases, since roundtrip time for the query/response is increased. A second factor is the cost associated with synchronizing the various redundant/accessory PSS servers.

A potential third factor (which most likely will be factored into the synchronization cost if not considered independently) may be the cost of “routing” through a node. For example, if a node “connects” two DAHWN networks and one of the networks uses PSS servers that are on the network, then that connecting node would benefit the other network by having a PSS located on it so that the network which does not have a PSS may simply use that PSS instead of routing to the other network.

The system may operate with two opposing forces that may draw the system into a particular state: “positive feedback” and “negative feedback”. Positive feedback is the reduced cost of access (the first factor). Negative feedback is the cost of synchronization (the second factor).

These two forces may oppose one another and provide criteria for making local decisions. For example, if there is more “positive” force at a node (reduced access cost), the node may become a PSS. If there is more “negative” force at a node (cost of synchronization outweighs access costs), the node may not become a PSS.

Further, if a node joins a network, the node may determine whether to be a PSS. Every node may first assume that it will be a PSS, and then decide not to. This decision is based on which of the two forces is stronger from the node's local viewpoint. The node determines whether a cost of accessing a PSS is greater (positive feedback) than a cost of synchronization with a PSS (negative feedback). Note that the cost for accessing a local PSS by the node is zero.

When both of these forces are equal (and thus canceling one another), the system may be in “equilibrium”, or a stable state. The system may remain in this state until an outside force interacts with the system or a system property changes. A node may join the network or the topology of the network may change.

Conventional emergence algorithms for performing this task (i.e., genetic algorithms, neural networks, etc.) typically take a significantly long time in converging to the desired solution. This overhead is an obvious disadvantage to conventional emergence algorithms. Thus, a self organizing system in accordance with the present invention is based on local decision making instead of a global decision making paradigm, such as the aforementioned genetic and neural networking schemes. The system may make necessary decisions to self organize much faster based on local information than by gathering global information. Thus, the system may quickly place a network into a stable, but yet non-optimum, state, even though a node, based on local information, considers itself optimized.

In such a case, a “smudge factor” may be utilized to “pop” the system out of the stable, yet non-optimum, state. Other special cases may require this as well. For example, a mesh-network may have all nodes interconnected. Any node joining this network could potentially opt out of becoming a PSS as synchronization costs between all the nodes may be higher than simply accessing a PSS. Thus, a network may have no PSS servers or a sub-optimum amount of PSS servers.

The “smudge factor” is introduced to “kick” the system out of this state and into the desired equilibrium. Any PSS server in the DAHWN network may act as a fully operational PSS. Thus, there is no “central” PSS in the DAHWN network. Every PSS is equivalent in terms of importance. When a service publishes itself to its closest PSS, that PSS may then distribute its state throughout the other PSS servers in the network. This is “synchronization” amongst the PSS servers.

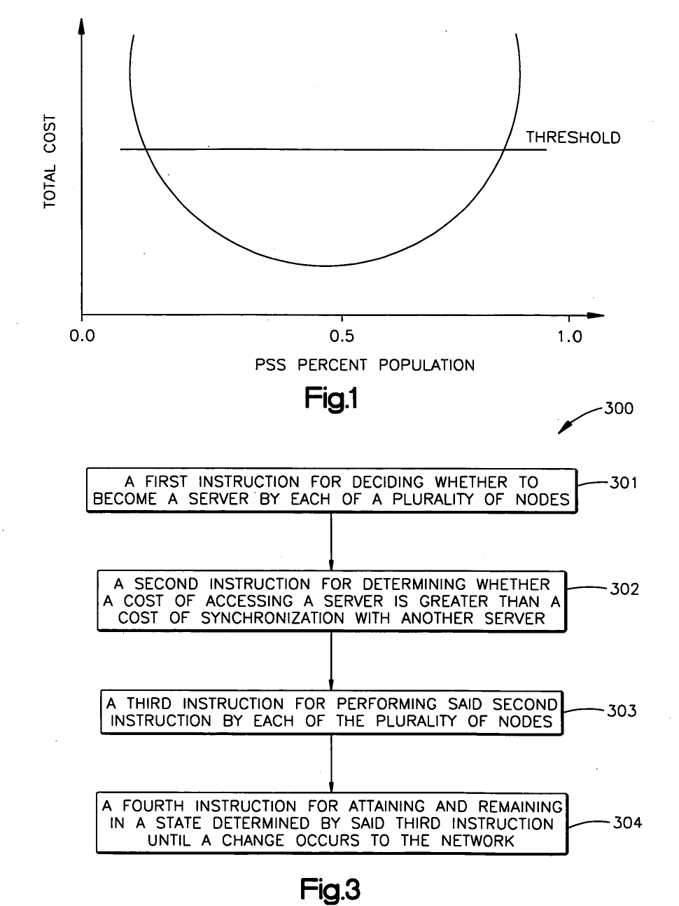

As shown in FIG. 1, the system may optimize these relationships to find a “sweet spot” that may determine the PSS behavior given the specific characteristics of the network in self-organizing itself. The system may determine the relationship (if any) between the factors outlined above and their effect on PSS QoS.

The system may determine an optimum PSS percentage for a given network. This is not the location of PSS services, only that for a given network of size N, X number of PSS to may keep the network in the stable or “minimum energy” state (assuming those X PSS services are placed in optimum locations).

The system may generate a random topology of nodes from a size N network (N=5 to 100) and for each network iterate through PSS percent population from 1/n to 1.0. The term “PSS Percent Population” is the percentages of nodes throughout the given network that have a PSS. So a percentage of 1/n means that there is only one PSS in the network where as a percentage of 1.0 means that all nodes in the network have a PSS on it. A pseudo code is given below:

```
//we iterate for the given list of network sizes
for(i=5; i<101; i+=5)
    //we iterate over numPSS/I where numPSS ranges
    from
    //1 to I to obtain the
    //percentage population of the given network
    for(pss=0; pss<1.20; pss+=.20)
        //here we calculate the average of the cost
        //for the given network after five
        iterations
        //five was chosen arbitrarily to get an
        adequate
        //representation on how that network
        behaves
        //for the given constraints
        for(j=0; j<5; j++)
            network = RANDOM(i)
            //randomly place the PSS in network
            network=PLACE_PSS(pss, network);
            cost=CALCULATE_COST(network)
            totalcost += cost
        end
    end
    PLOT(average(totalcost),pss)
end
```

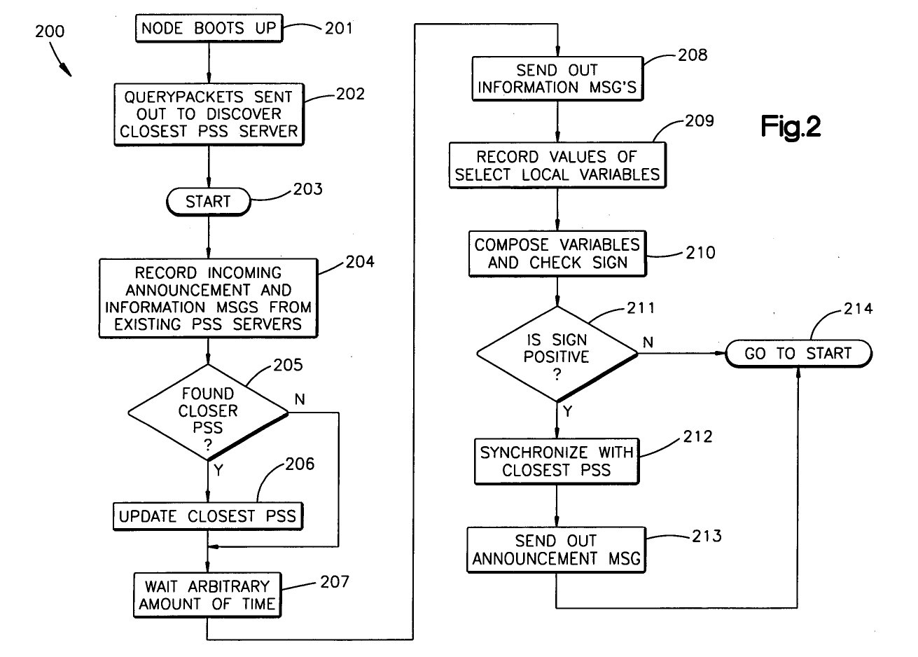

As shown in FIG. 2, an example system 200 may determine an optimal arrangement of servers within a mobile network. The system 200 begins when a specific node 201 boots up. Then system 200 proceeds to step 202. In step 202, the node 201 sends querypackets to determine a closest Publish Subscribe Server (PSS). From step 202, the system 200 proceeds to step 203. In step 203, the system 200 starts. From step 203, the system 200 proceeds to step 204. In step 204, the node 201 records an incoming announcement an information messages from existing PSS's. From step 204, the system 200 proceeds to step 205.

In step 205, the node 201 determines whether there is a closer PSS. If there is no closer PSS, the system 200 proceeds to step 207. If there is a closer PSS, the system 200 proceeds to step 206. In step 206, the node 201 updates its closest PSS. From step 206, the system 200 proceeds to step 207.

In step 207, the system 200 waits a predetermined amount of time. From step 207, the system 200 proceeds to step 208. In step 208, the node 201 sends out information messages. From step 208, the system 200 proceeds to step 209. In step 209, the node 201 records values of select local variables. From step 209, the system 200 proceeds to step 210. In step 210, the node 201 composes variables and checks a sign. From step 210, the system 200 proceeds to step 211.

In step 211, the node 201 determines whether the sign is positive. If the sign is negative, the system 200 proceeds to step 214. If the sign is positive, the system proceeds to step 212. In step 212, the node 201 synchronizes with the closest PSS. From step 212, the system 200 proceeds to step 213. In step 213, the node 201 sends out announcement messages. From step 213, the system proceeds to step 214. From step 214, the system 200 returns to step 202.

As shown in FIG. 2, another example system 200 in accordance with the present invention may include a plurality of nodes 201 of a mobile network. Each node decides whether to become a server by determining whether a cost of accessing a server is greater than a cost of synchronization with another server (step 211). The system 200 may attain and remain in a stable state by the decisions of each individual node 201.

As shown in FIG. 3, an example computer program product 300 in accordance with the present invention determines an optimal arrangement of servers within a mobile network. The computer program product 300 includes: a first instruction 301 for deciding whether to become a server by each of a plurality of nodes; a second instruction 302 for determining whether a cost of accessing a server is greater than a cost of synchronization with another server; a third instruction 303 for performing the second instruction 302 by each of the plurality of nodes; and a fourth instruction 304 for attaining and remaining in a state determined by the third instruction 303 until a change occurs to the network.

In order to provide a context for the various aspects of the present invention, the following discussion is intended to provide a brief, general description of a suitable computing environment in which the various aspects of the present invention may be implemented. While the invention has been described above in the general context of computer-executable instructions of a computer program that runs on a computer, those skilled in the art will recognize that the invention also may be implemented in combination with other program modules.

Generally, program modules include routines, programs, components, data structures, etc. that perform particular tasks or implement particular abstract data types. Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like. The illustrated aspects of the invention may also be practiced in distributed computing environments where tasks are performed by remote processing devices that are linked through a communications argument model. However, some, if not all aspects of the invention can be practiced on stand-alone computers. In a distributed computing environment, program modules may be located in both local and remote memory storage devices.

An exemplary system for implementing the various aspects of the invention includes a conventional server computer, including a processing unit, a system memory, and a system bus that couples various system components including the system memory to the processing unit. The processing unit may be any of various commercially available processors. Dual microprocessors and other multi-processor architectures also can be used as the processing unit. The system bus may be any of several types of bus structure including a memory bus or memory controller, a peripheral bus, and a local bus using any of a variety of conventional bus architectures. The system memory includes read only memory (ROM) and random access memory (RAM). A basic input/output system (BIOS), containing the basic routines that help to transfer information between elements within the server computer, such as during start-up, is stored in ROM.

The server computer further includes a hard disk drive, a magnetic disk drive, e.g., to read from or write to a removable disk, and an optical disk drive, e.g., for reading a CD-ROM disk or to read from or write to other optical media. The hard disk drive, magnetic disk drive, and optical disk drive are connected to the system bus by a hard disk drive interface, a magnetic disk drive interface, and an optical drive interface, respectively. The drives and their associated computer-readable media provide nonvolatile storage of data, data structures, computer-executable instructions, etc., for the server computer. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment, and further that any such media may contain computer-executable instructions for performing the methods of the present invention.

A number of program modules may be stored in the drives and RAM, including an operating system, one or more application programs, other program modules, and program data. A user may enter commands and information into the server computer through a keyboard and a pointing device, such as a mouse. Other input devices (not shown) may include a microphone, a joystick, a game pad, a satellite dish, a scanner, or the like. These and other input devices are often connected to the processing unit through a serial port interface that is coupled to the system bus, but may be connected by other interfaces, such as a parallel port, a game port or a universal serial bus (USB). A monitor or other type of display device is also connected to the system bus via an interface, such as a video adapter. In addition to the monitor, computers typically include other peripheral output devices (not shown), such as speaker and printers.

The server computer may operate in a networked environment using logical connections to one or more remote computers, such as a remote client computer. The remote computer may be a workstation, a server computer, a router, a peer device or other common network node, and typically includes many or all of the elements described relative to the server computer. The logical connections include a local area network (LAN) and a wide area network (WAN). Such networking environments are commonplace in offices, enterprise-wide computer networks, intranets and the internet.

When used in a LAN networking environment, the server computer is connected to the local network through a network interface or adapter. When used in a WAN networking environment, the server computer typically includes a modem, or is connected to a communications server on the LAN, or has other means for establishing communications over the wide area network, such as the internet. The modem, which may be internal or external, is connected to the system bus via the serial port interface. In a networked environment, program modules depicted relative to the server computer, or portions thereof, may be stored in the remote memory storage device. It will be appreciated that the network connections shown are exemplary and other means of establishing a communications link between the computers may be used.

In accordance with the practices of persons skilled in the art of computer programming, the present invention has been described with reference to acts and symbolic representations of operations that are performed by a computer, such as the server computer, unless otherwise indicated. Such acts and operations are sometimes referred to as being computer-executed. It will be appreciated that the acts and symbolically represented operations include the manipulation by the processing unit of electrical signals representing data bits which causes a resulting transformation or reduction of the electrical signal representation, and the maintenance of data bits at memory locations in the memory system (including the system memory, hard drive, floppy disks, and CD-ROM) to thereby reconfigure or otherwise alter the computer system's operation, as well as other processing of signals. The memory locations where such data bits are maintained are physical locations that have particular electrical, magnetic, or optical properties corresponding to the data bits.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim:

1. A system for determining an optimal arrangement of servers within a mobile network, said system comprising:
a plurality of nodes of the mobile network, each node deciding whether to become a server by determining whether a cost of accessing a server is greater than a cost of synchronization with another server,
said system attaining and remaining in a stable state by the decisions of each individual node.

2. The system as set forth in claim 1 wherein the stable state is a non-optimum state of the network.

3. The system as set forth in claim 2 further including a factor for urging said system from the non-optimum state.

4. The system as set forth in claim 3 wherein said factor operates to remove said system from a state having no servers.

5. The system as set forth in claim 1 further including a new node introduced into the network.

6. The system as set forth in claim 5 wherein said new node decides whether to become a server by determining whether a cost of accessing a server is greater than a cost of synchronization with another server.

7. The system as set forth in claim 6 wherein said system attains and remains in another stable state by the decisions of each individual node and said new node.

8. The system as set forth in claim 7 wherein the other stable state is a non-optimum state of the network.

9. The system as set forth in claim 8 further including a factor for urging said system from the non-optimum state.

10. The system as set forth in claim 9 wherein said factor operates to remove said system from a state having no servers.

11. A computer program product for determining an optimal arrangement of servers within a mobile network, said computer program product comprising:
a first instruction for deciding whether to become a server by each of a plurality of nodes;
a second instruction for determining whether a cost of accessing a server is greater than a cost of synchronization with another server;
a third instruction for performing said second instruction by each of the plurality of nodes; and
a fourth instruction for attaining and remaining in a state determined by said third instruction until a change occurs to the network.

12. The computer program product as set forth in claim 11 wherein the state determined by said third instruction is a non-optimum state of the network.

13. The computer program product as set forth in claim 12 further including a fifth instruction for urging the network from the non-optimum state.

14. The computer program product as set forth in claim 11 further including a fifth instruction for removing the network from a state having no servers.

15. The computer program product as set forth in claim 11 further including a fifth instruction for introducing a new node into the network.

16. The computer program product as set forth in claim 11 further including a fifth instruction for deciding, by a new node, whether to become a server by determining whether a cost of accessing a server is greater than a cost of synchronization with another server.

17. The computer program product as set-forth in claim 16 further including a sixth instruction for attaining and remaining in another stable state by the decisions of each individual node and the new node.

18. The computer program product as set forth in claim 17 wherein the other stable state is a non-optimum state of the network.

19. The computer program product as set forth in claim 11 further including a seventh instruction for urging the network system from the non-optimum state.

20. A method for determining an optimal arrangement of servers within a mobile network, said method comprising the steps of:
deciding whether to become a server by each of a plurality of nodes;
determining whether a cost of accessing a server is greater than a cost of synchronization with another server;
performing said determining step by each of the plurality of nodes;
attaining and remaining in a state determined by said performing step until a change occurs to the network; and
removing the network from a state having no servers.
